(19) United States
(12) Patent Application Publication
(10) Pub. No.: US 2026/0287130 A1
(43) Pub. Date: Sep. 24, 2026

(54) Lighting tube for refrigerator

(71) Applicant: ENERGYLED ELECTRONICS CORPORATION, Zhaoqing City (CN)

(72) Inventors: Deliang XIAO, Zhaoqing City (CN); Zixiang XIAO, Zhaoqing City (CN); Qing MA, Zhaoqing City (CN); Kegang YUE, Zhaoqing City (CN); Chao Hsien WU, Zhaoqing City (CN)

(21) Appl. No.: 19/438,273

(22) Filed: Dec. 31, 2025

(30) Foreign Application Priority Data
Mar. 24, 2025 (CN) 202520526709.9

(51) Int. Cl. F21S 4/28; F21W 131/305; F21Y 115/10; F25D 27/00

(52) U.S. Cl. CPC F21S 4/28; F25D 27/00; F21W 2131/305; F21Y 2115/10

(57) ABSTRACT

A lighting tube for a refrigerator includes a base; a lampshade snap-fitted to the base, which is inwardly formed with a plurality of clamping grooves at a top portion and a bottom portion thereof; at least one LED light source module, with one end thereof selectively disposed in one clamping groove at the top portion of the lampshade and the other end thereof selectively disposed in one clamping groove at the bottom portion of the lampshade, where an illumination angle of the at least one LED light source module is adjustable in response to being disposed in different clamping grooves; and a power supply component disposed on the base.

### CROSS REFERENCE TO RELATED APPLICATIONS

The present application claims priority from Chinese Application No. CN 202520526709.9 filed on Mar. 24, 2025, all of which are hereby incorporated herein by reference.

### TECHNICAL FIELD

The present disclosure relates to the technical field of lighting fixtures, and in particular, to a lighting tube for a refrigerator.

### BACKGROUND

With rapid development of the retail industry, malls and supermarkets have increasingly higher requirements for commodities display effects. In the fields of cold chain logistics and food preservation, refrigerators are key equipment for storing and displaying commodities such as frozen foods, beverages and ice creams. However, in the current lighting application of supermarket refrigerators, the light-emitting angle or light effect of the lighting tube cannot be controlled, resulting in lower effective area illumination, which fails to highlight the lighting effect. Moreover, the current lighting tube requires numerous additional components, leading to complex manufacturing processes, unsatisfactory sealing performance, and high production cost. In addition, due to uneven refraction or reflection of light at connection portions of the current lighting tube, the light distribution in the illumination area becomes uneven, causing irregular yellow lines or shadows in the refrigerator. This not only affects the lighting effect, but may also impair the display effect of the commodities.

It is therefore desirable to propose an improved lighting tube for a refrigerator with a reasonable optical design for a lighting tube structure and a light source position.

### SUMMARY

One aspect of present disclosure provides a lighting tube for a refrigerator, including a base; a lampshade snap-fitted to the base, which is inwardly formed with a plurality of clamping grooves at a top portion and a bottom portion thereof; at least one LED light source module, with one end thereof selectively disposed in one clamping groove at the top portion of the lampshade and the other end thereof selectively disposed in one clamping groove at the bottom portion of the lampshade, where an illumination angle of the at least one LED light source module is adjustable in response to being disposed in different clamping grooves; and a power supply component disposed on the base.

Second aspect of present disclosure provides a refrigerator, including a refrigerator body and the lighting tube for illuminating the inner side of the refrigerator body.

Third aspect of present disclosure provides a method of use of the lighting tube, including fixing the lighting tube to a refrigerator; and adjusting the illumination angle of the at least one LED light source module by selectively disposing the at least one LED light source module in different clamping grooves.

### BRIEF DESCRIPTION OF THE DRAWINGS

FIG. 1 is a sectional view of a lighting tube with double-side light emitting effect according to an embodiment of the present disclosure;

FIG. 2 is a sectional view of a lighting tube with single-side light emitting effect according to an embodiment of the present disclosure;

FIG. 3 is a sectional view of a light-emitting element along the length direction of the lighting tube; and

FIG. 4 is a schematic view showing a lighting tube in use according to the present disclosure.

### DETAILED DESCRIPTION OF THE EMBODIMENTS

The accompanying drawings of the present disclosure are only used for exemplary illustration, and should not be construed as limiting the present disclosure. For better explanation of the following embodiments, some parts in the accompanying drawings may be omitted, enlarged or reduced, and do not represent the actual size of a product. It can be understood by those skilled in the art that some well-known structures and their descriptions may be omitted in the accompanying drawings.

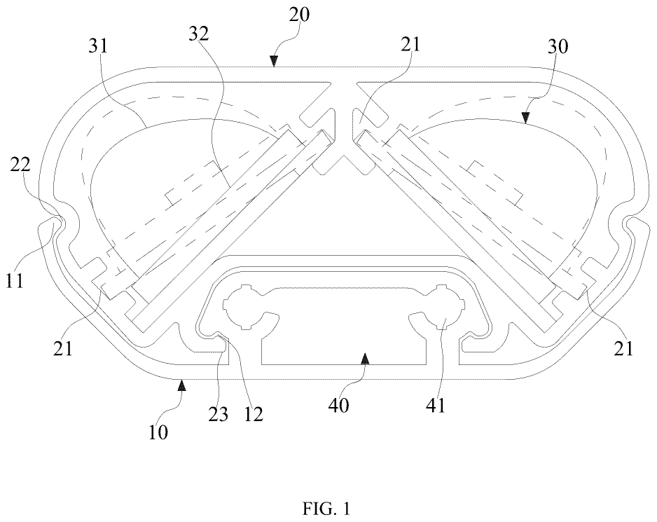

FIG. 1 shows a sectional view of a lighting tube for a refrigerator with double-side light emitting according to an embodiment of the present disclosure. The lighting tube in the present embodiment includes a base 10, a lampshade 20 snap-fitted to the base 10, two LED light source modules 30, and a power supply component 40 disposed on the base 10. A plurality of clamping grooves 21 are inwardly formed at the top portion and bottom portion of the lampshade 20. One end of each LED light source module 30 is selectively disposed in one clamping groove 21 at the top portion of the lampshade 20, and the other end thereof is selectively disposed in one clamping groove 21 at the bottom portion of the lampshade 20. An illumination angle of each LED light source module 30 is adjustable by disposing the corresponding LED light source module 30 in different clamping grooves 21.

In this embodiment, the LED light source module 30 in the lighting tube can be selectively clamped into different clamping grooves 21, especially at the bottom portion of the lampshade 20, so as to adjust the inclination angle of the LED light source module 30, thereby achieving change of illumination angles to allow the light emitted from the light source module 2 to be projected over a wider angle onto the illumination surface of the illuminated, which thus can produce stronger illumination strength and effectively improve the light effect to meet the needs for various angles of customers. In addition, the snap-fit connection between the lampshade 20 and the base 10 further ensures a more secure assembly of the lighting tube, thereby providing improved stability.

As illustrated in FIG. 1, the cross section of the clamping groove 21 at the top portion of the lampshade 20 is in a fishbone-shaped structure, which can simultaneously accommodate one end of the two LED light source modules 30. This configuration is especially advantages for the case that more than one LED light source module 30 is provided.

A plurality of recessed portions are formed between adjacent branches of the fishbone-shaped structure, which defines the clamping grooves 21 at the top portion of the lampshade 20 to accommodate one end of the two LED light source modules 30. This makes the whole lighting tube more compact in structure, thereby saving space.

Furthermore, in this embodiment, both ends of the bottom portion of the lampshade close to the power supply component 40 are respectively provided with a plurality of clamping grooves 21 for clamping the other end of the two light source modules 20.

In particular, a plurality of recesses 22 are further formed in the outer surface of the lampshade 20 in this embodiment, and a plurality of protrusions 7 are correspondingly provided on the base 10. The protrusions 7 are matched with the recesses 6 in the lampshade 20 in shape and size to achieve engagement between the lampshade 20 and the base 10.

Through such protrusion-recess mating mode, the lighting tube can be quickly assembled and disassembled. This can also prevent loosening during the connection, thereby improving connection stability.

In addition, a plurality of hook members 23 are further provided on the lampshade 20, and a plurality of grooves 9 are correspondingly formed on the base 10. The grooves 9 of the base 10 are adapted to the hook members 23 on the surface of the lampshade 20 in depth and shape to achieve secure engagement therebetween.

In the present embodiment, the hook members 23 of the lampshade 20 are inserted into the grooves 9 of the base 10 to achieve snap-fit connection through a certain amount of external pressure, thereby forming a reliable clamping effect, which can not only further improve the connection reliability, but also simplify the assembly, largely reducing the components and time consuming required by traditional connection methods. Additionally, the structure in the present embodiment also has better wear resistance, making it suitable for use in a variety of complex environments.

The lampshade 20 in the present embodiment is made of white transparent material, so that the light from the LED light source module 30 can be projected to the outside environment.

Except projecting the light emitted from the LED light source module 30 to the outside, the white lampshade 20 can also enhance reflection of the light, making the illumination brighter and more uniform, which can improve the user experience.

Particularly, the LED light source module 30 includes a lens 31 and a light-emitting element 32. The lens 31 is preferably a plano-convex lens. The light-emitting element 32 is disposed on a flat surface of the plano-convex lens 31 and has a light-emitting direction facing the lens 31. The light produced by the light-emitting element 32 passes through the lens and is finally emitted from an arc surface of the plano-convex lens 31.

According to the principles of Fresnel Optics, the convex structure of the lens 31 exhibits excellent optical transmittance. When the light is emitted perpendicularly through a light-outputting surface, the light-emitting efficiency is maximized. The light emitted from the lens 31 then passes through the lampshade 20 and diffuses outwardly, which produces more uniform light dispersion.

Referring to FIG. 3, the light-emitting element 32 particularly includes a light strip 321 having a heat-dissipation circuit and a plurality of light beads 322 thereon. The light beads 322 are evenly distributed along a central line of the light strip 321, and both sides of the light strip 321 are respectively clamped into the clamping grooves 21 at the top and bottom portion of the lampshade 20.

The light strip 321, due to its better flexibility, can be easily installed in the clamping grooves 21. In addition, the light strip 321 having heat-dissipation circuit generates less heat, which thus prolongs the service life of the lighting tube. Moreover, the plurality of light beads 322 evenly distributed on the light strip 321 allows the light emitted from the lighting tube more uniform and softer, thereby further improving the light effect.

The lampshade 20 in this embodiment is of a sealed design, and is preferably integrally molded, which can improve waterproof performance of the lighting tube.

The integral configuration of the lampshade 20 can prevent moisture inside the refrigerator from entering the lighting tube and damaging the LED light source module 30, thereby further prolonging the service life of the lighting tube.

In this embodiment, two LED light source modules 2 are provided, which are individually distributed at two sides of the fishbone-shaped clamping groove 21 at the top portion of the lampshade 20.

A power socket 12 is formed in the base 10 for enabling the lighting tube to be installed in a lighting fixture inside the refrigerator for power connection.

The power socket 12 can simplify the connection between the lighting tube and the lighting fixture inside the refrigerator. Therefore, power connection can be achieved only by inserting the lighting tube into the socket, which reduces complexity of traditional wiring, and thus improves installation efficiency. Moreover, the socket design eliminates bare wires to prevent the wires from being exposed externally, thereby effectively reducing the risk of electric shock or short circuit of the power supply in a humid environment of the refrigerator. In the present disclosure, by fixing the position of the power socket 12 for power connection, the connection is more stable and secure. In addition, the power socket 12 can also ensure that the lighting tube can be stably powered when installed in the lighting fixture of the refrigerator, avoiding malfunction of the lighting tube due to unsatisfactory contact, thereby improving reliability and long-term use effect of the equipment.

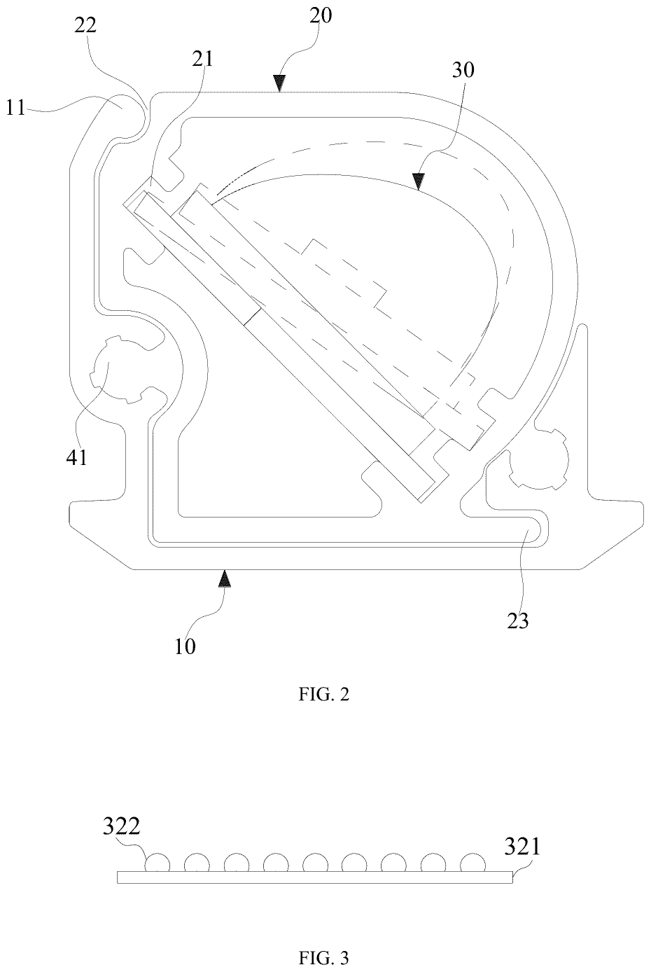

FIG. 2 shows a sectional view of a lighting tube with single-side light-emitting according to an embodiment of the present disclosure. In this embodiment, only one LED light source module 30 is provided. The clamping grooves 21 at the top and bottom portion of the lampshade 20 form a step shape.

In FIG. 1 and FIG. 2, the LED light source module 30 before adjustment of illumination angle is indicated by the solid lines, while the LED light source module 30 after change of inclination angle is indicated by the dashed lines.

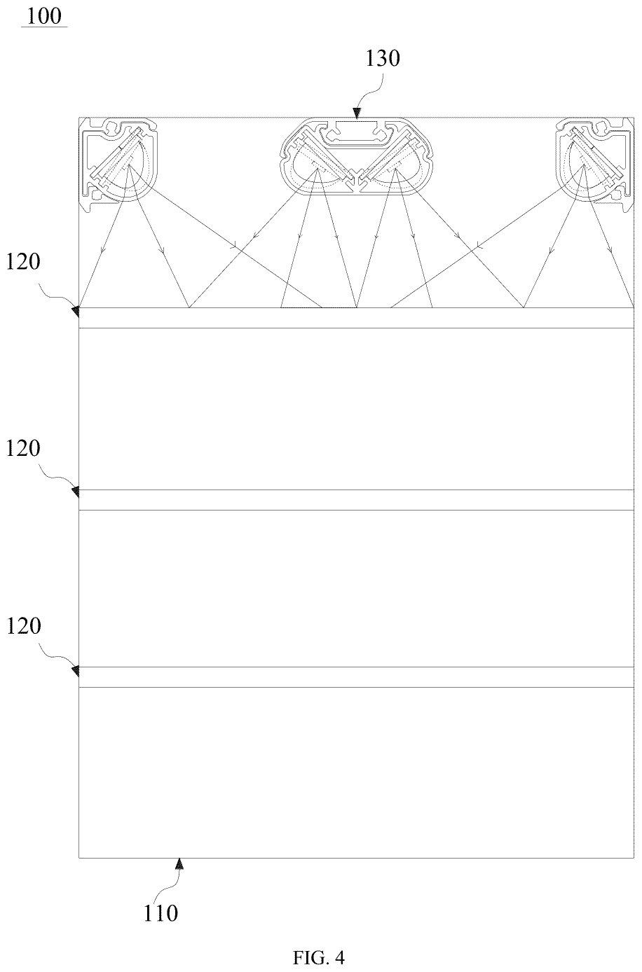

FIG. 4 shows a sectional view of a refrigerator 100. The refrigerator 100 in this embodiment includes a refrigerator body 110, shelves 120 optionally provided inside the refrigerator 110, and a lighting tube 130 mentioned above fixed inside the refrigerator 110 for illuminating the shelves 120. The lighting tube 130 can be arranged in the middle portion of the top of the refrigerator body 110. The lighting tube 130 can also be arranged in the side portion of the top of the refrigerator body 110. As an example, the refrigerator 100 as illustrated in FIG. 4 includes three lighting tubes 130, one arranged in the middle portion, and two arranged in the side portions.

As shown, when disposed in the middle portion of the top of the refrigerator body 110, the lighting tube 130 is provided with two LED light source modules 30, as shown in FIG. 1, which allows light to be emitted in all directions and evenly dispersed to the center and surrounding areas of the refrigerator. In this situation, the cross section of the clamping groove 21 at the top portion of the lampshade 20 is of a fishbone-shaped structure, and both ends of the bottom portion of the lampshade 20 close to the power supply component 40 are respectively provided with a plurality of clamping grooves 21, one end of each LED light source module 30 is clamped into the fishbone-shaped structure, and the other end of each LED light source module 30 is correspondingly clamped into one clamping groove 21 at each end of the bottom portion of the lampshade 20.

While when disposed close to the side portion of the refrigerator body 110, the lighting tube 130 is provided with only one LED light source module 30, as shown in FIG. 2.

The inclination angle of the LED light source module 30 can be adjusted by positioning the LED light source module in different clamping grooves 21 to allow the light to be directed toward the center of the refrigerator 100 and simultaneously evenly illuminated the side areas of the refrigerator 100, thereby enabling the light to illuminate the entire interior of the refrigerator 100, effectively improving the effective area illumination and enhancing the light effect. In the refrigerator 100 of the present embodiment, the selecting and setting of the number of the LED light source module 30 in the lighting tube according to the installation position of the lighting tube achieves more diverse illumination angle of the lighting tube, which thus can obtain different light effects to meet different customer requires.

The lighting tube according to the present disclosure has wider illumination angle and stronger illumination intensity, with the illumination uniformity reaching 230% or above.

While preferred embodiments have been shown and described, various modifications and substitutions may be made thereto without departing from the spirit and scope of the disclosure. Accordingly, it is to be understood that the present disclosure has been described by way of illustration and not limitation.

What is claimed is:

1. A lighting tube for a refrigerator, comprising
a base;
a lampshade snap-fitted to the base, which is inwardly formed with a plurality of clamping grooves at a top portion and a bottom portion;
at least one LED light source module, with one end thereof selectively disposed in one clamping groove at the top portion of the lampshade and the other end thereof selectively disposed in one clamping groove at the bottom portion of the lampshade, wherein an illumination angle of the at least one LED light source module is adjustable in response to being disposed in different clamping grooves; and
a power supply component disposed on the base.

2. The lighting tube for a refrigerator according to claim 1, wherein a cross section of the clamping groove at the top portion of the lampshade is of a fishbone-shaped structure, which is used to clamp one end of the at least one light source module.

3. The lighting tube for a refrigerator according to claim 2, wherein both ends of the bottom portion of the lampshade close to the power supply component are respectively provided with a plurality of clamping grooves for clamping the other end of the at least one light source module.

4. The lighting tube for a refrigerator according to claim 1, wherein a plurality of recesses are formed in an outer surface of the lampshade, a plurality of protrusions are provided on the base corresponding to the plurality of recesses, and the plurality of protrusions are respectively engaged in the plurality of recesses.

5. The lighting tube for a refrigerator according to claim 1, wherein a plurality of hook members are provided on an outer surface of the lampshade, a plurality of grooves are formed in the base corresponding to the plurality of hook members, and the plurality of grooves are respectively engaged in the plurality of the hook members.

6. The lighting tube for a refrigerator according to claim 1, wherein the lampshade is made of white transparent material and configured to project light from the at least one LED light source module to outside.

7. The lighting tube for a refrigerator according to claim 1, wherein the at least one LED light source module comprises
a lens, which includes a plano-convex lens; and
a light-emitting element disposed on a flat surface of the plano-convex lens, which has a light-emitting direction facing the lens, wherein light produced by the light-emitting element is emitted from an arc surface of the plano-convex lens.

8. The lighting tube for a refrigerator according to claim 7, wherein the light-emitting element comprises a light strip having a heat-dissipation circuit and a plurality of LED beads evenly distributed along a central line of the light strip, with two ends of the light strip respectively clamped into the clamping grooves at the top portion and the bottom portion of the lampshade.

9. The lighting tube for a refrigerator according to claim 1, wherein the lampshade is integrally formed.

10. The lighting tube for a refrigerator according to claim 1, wherein a power socket is formed in the base for power connection.

11. A refrigerator, comprising a refrigerator body and the lighting tube according to claim 1 for illuminating an inner side of the refrigerator body.

12. The refrigerator according to claim 11, wherein the lighting tube having two LED light source modules is arranged at a middle portion of a top of the refrigerator body, a cross section of the clamping groove at the top portion of the lampshade is of a fishbone-shaped structure, and both ends of the bottom portion of the lampshade close to the power supply component are respectively provided with a plurality of clamping grooves, one end of each LED light source module is clamped into the fishbone-shaped structure, and the other end of each LED light source module is correspondingly clamped into one clamping groove at each end of the bottom portion of the lampshade.

13. The refrigerator according to claim 11, wherein the lighting tube is arranged on a side portion of a top of the refrigerator body, and the lighting tube has only one LED light source module.

14. The refrigerator according to claim 11, wherein a plurality of recesses are formed in an outer surface of the lampshade, a plurality of protrusions are provided on the base corresponding to the plurality of recesses, and the plurality of protrusions are respectively engaged in the plurality of recesses.

15. The refrigerator according to claim 11, wherein a plurality of hook members are provided on an outer surface of the lampshade, a plurality of grooves are formed in the base corresponding to the plurality of hook members, and the plurality of grooves are respectively engaged in the plurality of the hook members.

16. A method of use of the lighting tube according to claim 1, comprising:
fixing the lighting tube to a refrigerator; and
adjusting the illumination angle of the at least one LED light source module by selectively disposing the at least one LED light source module in different clamping grooves.

17. The method according to claim 16, wherein the lighting tube having two LED light source modules is fixed to a middle portion of a top of the refrigerator, a cross section of the clamping groove at the top portion of the lampshade is of a fishbone-shaped structure, and both ends of the bottom portion of the lampshade close to the power supply component are respectively provided with a plurality of clamping grooves, with one end of each LED light source module clamped into the fishbone-shaped structure, and the other end of each LED light source module correspondingly clamped into one clamping groove at each end of the bottom portion of the lampshade.

18. The method according to claim 16, wherein the lighting tube having one LED light source module is fixed to a side portion of the top of the refrigerator.
